(19) United States
(12) Patent Application Publication
(10) Pub. No.: US 2005/0269806 A1
(43) Pub. Date: Dec. 8, 2005

(54) Airbag protective device for vehicle occupants and motor vehicle

(76) Inventors: Eduard Huber, Alling (DE); Ranier Schroter, Reichertshausen (DE)

Correspondence Address: BRINKS HOFER GILSON & LIONE, P.O. BOX 10395, CHICAGO, IL, 60610, US

(21) Appl. No.: 11/143,072

(22) Filed: Jun. 2, 2005

(30) Foreign Application Priority Data
Jun. 2, 2004 (DE) 10 2004 026 778.2

(51) Int. Cl. B60R 21/22

(52) U.S. Cl. 280/730.2

(57) ABSTRACT

A side curtain airbag for providing occupant protection in a laterally displaced front crash. The side curtain airbag in the installed state extends from the A-pillar to at least the B-pillar of the vehicle. In the region of the airbag assigned to the head of an occupant sitting on the front seat of the vehicle, the airbag forms at least two chambers located one behind the other, in the inflated state of the airbag, the maximum clearance of the side walls in the front chamber is larger than in the rear chamber.

### CROSS REFERENCE TO RELATED APPLICATION

This application claims priority to DE 10 2004 026 778.2, filed Jun. 2, 2004.

### FIELD OF THE INVENTION

The invention relates to a protective device for vehicle occupants in the form of an airbag occupant restraint device.

### BACKGROUND OF THE INVENTION

To protect the occupants seated in front, many modern motor vehicles divide the tasks of the airbag systems that are used for frontal impact condtions and those provided for side impacts.

A pillow-shaped airbag, which absorbs the kinetic energy of head and chest of an occupant in a frontal crash, is typically located in the steering wheel and in the glove-compartment (passenger side) region of the instrument panel. Moreover, a side curtain airbag, which is configured two-dimensionally and features two side walls, is arranged in the vicinity of the roof rail. The side curtain airbag is mainly intended to prevent the head of an occupant from coming into contact with a side window or B-pillar (the pillar behind the front door). To accommodate a side curtain airbag the headliner in the vicinity of the roof rail is designed to open so that the expanding side curtain airbag can enter the passenger compartment of the vehicle.

There exists one problematic situation in the case of a laterally displaced frontal crash in which it is possible for the head of a front-seated occupant to miss both the pillow-shaped frontal airbag and the side curtain airbag, or to slide along the surface of the side curtain airbag so that the head can come into direct contact with the A-pillar. This may happen in particular if the occupant is not properly restrained by a seatbelt. Efforts are currently underway to improve occupant protection in this special accident situation. If no completely new or additional protective devices are to be introduced, there exists the option of structural revision of the front airbags or of the side curtain airbags. EP 0 832 795 B1 for example follows the latter path. That specification describes a side curtain airbag that features and additional chamber that inflates directly in front of the A-pillar and is held in place by a rebound strap. In this fitting arrangement, an airbag chamber is thus located directly in front of the A-pillar, preventing the head of an occupant from directly hitting the A-pillar.

A disadvantage of the protective device described in EP 0 832 795 B1 is that the side curtain airbag must extend up to behind the interior panel of the A-pillar. This significantly complicates the installation of the side curtain airbag in comparison to past side curtain airbags.

Proceeding from the state of the art, it is the object of the invention to further develop a protective device for vehicle occupants which is integrated into a motor vehicle providing simplified installation of the side curtain airbag and yet achieves good protection of the occupant in a lateral frontal crash.

### SUMMARY OF THE INVENTION

According to present invention, a side curtain airbag is so designed that the chamber that is intended to keep the head of the occupant from colliding with the A-pillar is not located directly in front of the A-pillar in its unfolded state, but projects into the interior of the motor vehicle in such a manner that the trajectory of the head is deflected toward the center of the vehicle at a relatively earlier time. In particular, the head may be guided in the direction of a front airbag.

To accomplish this, the side curtain airbag includes a front chamber whose maximum thickness is larger than the maximum thickness of a rear chamber located behind the front chamber in the direction of travel.

The design of the side curtain airbag of this invention makes it possible to be arranged, like past airbags, exclusively with its upper edge in the vicinity of the roof rail. In other words, packing the side curtain airbag into the A-pillar region is unnecessary, so that the installation cost does not increase. The side curtain airbag of this invention nevertheless provides protection of the occupant in the event of a laterally displaced oblique impact.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

Preferred embodiments result from the dependent claims and from the exemplary embodiment that will now be described in more detail based on the figures. The drawing shows:

FIG. 1 is a lateral view of a curtain airbag in accordance with this invention,

FIG. 2 is a longitudinal section through the curtain airbag depicted in FIG. 1 along the section line A-A, and

FIG. 3 shows the side curtain airbag depicted in FIG. 1, installed in a motor vehicle and in its inflated state.

### DETAILED DESCRIPTION OF THE INVENTION

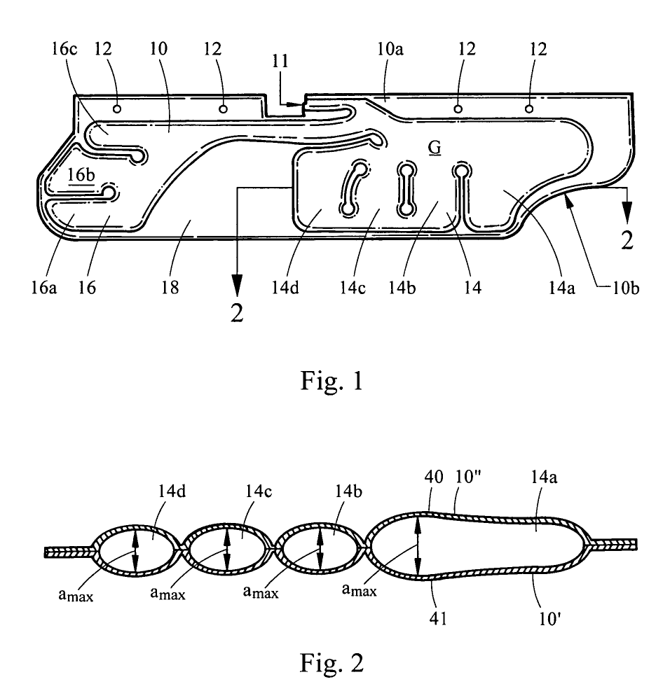

FIG. 1 shows a side curtain airbag 10 according to invention. The upper region 10a of airbag 10 features fastening elements 12 that permit the curtain airbag 10 to be arranged in the vicinity of the roof rail in a vehicle. The gas inlet 11, to which a gas generator (not illustrated) is attached, is furthermore located in the vicinity of the upper edge 10a.

The curtain airbag 10 forms a front region 14, a rear region 16 and an intermediate region 18 located therebetween. Front region 14 and rear region 16 are largely occupied by a continuous gas-filled compartment G. The gas-filled compartment G is subdivided into a plurality of chambers.

The front region 14 is divided into a number of chambers with the front chamber 14a, which in its installed state serves to keep the head of an occupant from colliding with the A-pillar in an oblique impact, is located at the front end of the curtain airbag 10. Three additional rear chambers 14b, 14c and 14d of front region 14 are located behind the front chamber 14a. The chamber assigned to the backseat region is likewise subdivided into three chambers, namely the rear region chambers 16a, 16b, and 16c. The intermediate region 18, which is located between the chamber 14d and the rear chambers 16a, 16b, and 16c, does not have any gas filled chambers.

FIG. 2 shows a longitudinal section through the front chamber 14a and rear chambers 14b-14d along the section line A-A of FIG. 1 in the completely inflated state of airbag 10. As can be seen, the front chamber 14a is thicker than the rear chambers 14b-14d; i.e. the maximum clearance of the side walls 40 and 41 of the curtain airbag 10 is larger in the front chamber 14a than in the rear chambers 14b-d. In the exemplary embodiment explained here, the maximum lateral clearance (aₘₐₓ) of the side walls 40 and 41 in the front chamber 14a amounts to a range of 120 mm to 170 mm and preferably approximately 150 mm and in the rear chambers 14b through 14d the maximum lateral clearance amounts to a range of 60 mm to 110 mm and preferably approximately 90 mm. The exact geometry depends on the particular case, but it is nevertheless preferred that the maximum lateral clearance in the front chamber 14a amount to approximately 1.5 times the maximum clearance in one or more of rear chambers 14b-14d.

The exemplary embodiment illustrated here shows a curtain airbag 10 that extends from the A-pillar to the C-pillar in the installed state and is thus suitable for a 4-seat or 5-seat automobile. However, the curtain airbag 10 according to invention may also be configured in such a manner that it extends only from the A-pillar to the B-pillar and is thus also suitable in particular for 2-seat motor vehicles.

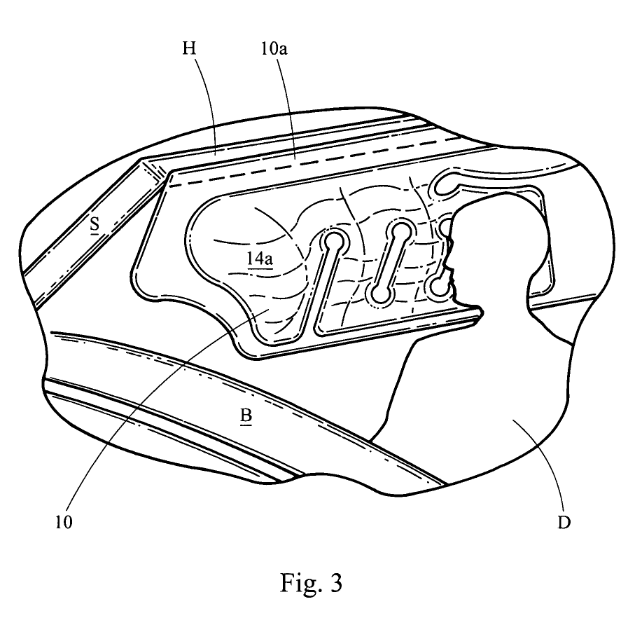

FIG. 3 shows a perspective diagram of a curtain airbag 10 installed and expanded in a motor vehicle. As can be seen, the upper edge 10a extends up to the transition region between the roof rail H, to which the curtain airbag 10 is fastened, and the A-pillar S. A rebound strap may be used to connect, either directly or indirectly, the curtain airbag 10 to the A-pillar S itself so that so that the interior panel of the A-pillar does not require any predetermined breaking points or the like.

The layer thickness of the front chamber 14a causes the curtain airbag 10 to extend up into the connecting line between the head of the occupant D (if the occupant is seated in the standard seating position) and the A-pillar S. In the event of an obliquely displaced front crash, the front chamber 14a will either absorb the kinetic energy of the head directly or deflect it in the direction of a front airbag (not illustrated).

As seen in FIGS. 1 through 3, a portion of the front edge 10b of the curtain airbag 10 curves inwards. This curvature makes it possible to arrange the curtain airbag 10 so that the upper edge 10a extends up to the end of the roof rail H. This characteristic is important in many vehicles, because it permits the front chamber 14a to be arranged far enough forward in the motor vehicle that the outcome according to invention, namely the protection of the head of the occupant from a collision with the A-pillar, is achieved.

In accordance with another embodiment of this invention, it may be provided that the upper edge of the curtain airbag 10 extend over the end of the roof rail H into the region of the A-pillar S. In this case however, the foremost connection point of the curtain airbag 10 is still located within the vicinity of the roof rail H. During the inflation of airbag 10, the region of the front chamber 14a that is located far from the gas-inlet area of the curtain airbag 10 is pulled out behind the A-pillar panel without damaging it. To keep the folded airbag 10 in this region behind the A-pillar panel as small as possible, the lower front region 10b, as depicted in FIG. 1 for example, may be recessed in the shape of a radius or slope. This shape of the front chamber 14a furthermore acts in such a manner that the lower region 10b of the front chamber supports the upper region so that the upper region does not bend downwards.

While the above description constitutes the preferred embodiment of the present invention, it will be appreciated that the invention is susceptible to modification, variation and change without departing from the proper scope and fair meaning of the accompanying claims.

1. A side curtain airbag of the type mounted along a roof rail of a motor vehicle and positioned in an installed state extending from a generally vertically extending A-pillar separating a windshield and a side window of the vehicle, rearwardly along of the side of the vehicle for providing impact protection for occupants of the motor vehicle, the side curtain airbag comprising, two side walls of fabric material which are affixed together to form a plurality of chambers which are inflatable by a gas generator to provide impact protection for the occupants of the vehicle, the side curtain airbag forming at least a first and a second chamber with the first chamber positioned forward of the second chamber and adjacent to the A-pillar, wherein in the inflated state of the airbag, the maximum lateral clearance of the side walls in the first chamber is larger than the maximum lateral clearance of the side walls in the second chamber.

2. A side curtain airbag according to claim 1, wherein the maximum lateral clearance of the side walls in said the first chamber is approximately 1.5 times the maximum lateral clearance of the second chamber.

3. A side curtain airbag according to claim 1, wherein the maximum lateral clearance of the side walls in the first chamber is between 120 and 170 mm.

4. A side curtain airbag according to claim 1 wherein the maximum lateral clearance of the side walls in the second chamber is between 60 and 110 mm.

5. A side curtain airbag according to claim 1, at least a third chamber is formed by the airbag and positioned rearward of the second chamber.

6. A side curtain airbag according to claim 1, wherein an edge of the curtain airbag is slanted toward the rear from top to bottom of the airbag.

7. A side curtain airbag according to claim 1 wherein the first and second chambers are connected together.

8. A side curtain airbag according to claim 1 wherein exclusively an upper region of at least a front section of the curtain airbag connects to the interior structure of the vehicle in the vicinity of the roof rail.

9. A side curtain airbag according to claim 1 wherein an upper fastening edge of the curtain airbag extends up to a transition region between the roof rail and the A-pillar.

10. A side curtain airbag according to claim 1 wherein the airbag further defines a rear region having one or more rear region chambers positioned rearward of the first and the second chambers.

11. A side curtain airbag according to claim 10 wherein the airbag further defines an intermediate region positioned between the first and second chambers and the rear region.
